(19) United States
(12) Patent Application Publication
(10) Pub. No.: US 2026/0023767 A1
(43) Pub. Date: Jan. 22, 2026

(54) INFORMATION PROCESSING APPARATUS, STORAGE MEDIUM AND CONTROL METHOD FOR THE INFORMATION PROCESSING APPARATUS

(71) Applicant: CANON KABUSHIKI KAISHA, Tokyo (JP)

(72) Inventor: TOMOYA ISHIDA, Kanagawa (JP)

(21) Appl. No.: 19/268,242

(22) Filed: Jul. 14, 2025

(30) Foreign Application Priority Data
Jul. 16, 2024 (JP) 2024-113441

(51) Int. Cl. G06F 16/3329; H04N 1/00

(52) U.S. Cl. CPC G06F 16/33295; H04N 1/00403; H04N 1/00474

(57) ABSTRACT

An information processing apparatus includes a display configured to display a screen, an acceptance unit configured to accept a natural language from a user, a transmission unit configured to transmit information about the screen displayed when the acceptance unit accepts the natural language and a prompt using the accepted natural language, the information being transmitted being based on the accepted natural language, and a reception unit configured to receive an output from a language model, the output being based on the transmitted information about the screen and the transmitted prompt. The display is caused to display the received output from the language model, the output indicating an operation method for the information processing apparatus that is displayed on the screen displayed by the display after the acceptance unit accepts the natural language.

This application claims the benefit of Japanese Patent Application No. 2024-113441, filed Jul. 16, 2024, which is hereby incorporated by reference herein in its entirety.

### BACKGROUND

### Field of the Technology

The present disclosure relates to an information processing apparatus, and a storage medium and a control method for the information processing apparatus.

### Description of the Related Art

Services are known, such as ChatGPT, in which users ask questions in natural languages and language models answer the user's questions in natural languages. Japanese Patent Application Laid-Open No. 2023-76413 discusses a technique of inputting a document of a specific domain to a language model to create query data predicted from the document, and answering a user's question using the query data and a search model.

When a user operating software wants to display a certain screen, in some cases, the user does not know what operation the user should perform on a user interface (UI) of the software to display the screen.

Some multifunction peripherals having functions, such as a printing function and a scanning function in particular, include a small operation panel on which users need to perform a lot of screen operations to display a desired screen. For example, a desired screen is displayed by selecting a button “a” on a screen A to transition to a screen B and then selecting a button “b” on a screen B to transition to a screen C.

A complicated screen transition method or an operation method for displaying a desired screen can be found by a user's inputting a question in a natural language into a language model. The language model is not aware of a screen being displayed on an operation panel when a user asks a question, so that the language model cannot provide a method of navigating from that screen to a desired screen.

### SUMMARY

According to an aspect of the present disclosure, an information processing apparatus includes a display configured to display a screen, at least one memory storing instructions, and at least one processor that, upon execution of the stored instructions, is configured to operate as an acceptance unit that accepts a natural language from a user, a transmission unit that transmits information about the screen displayed when the acceptance unit accepts the natural language and a prompt using the accepted natural language, the information being transmitted being based on the accepted natural language, and a reception unit that receives an output from a language model, the output being based on the transmitted information about the screen and the transmitted prompt. The display is caused to display the received output from the language model, the output indicating an operation method for the information processing apparatus that is displayed on the screen displayed by the display after the acceptance unit accepts the natural language.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system.

FIG. 2 is a diagram illustrating an example of a configuration of a printing apparatus.

FIG. 3 is a diagram illustrating an example of a configuration of an information processing apparatus.

FIG. 4 is a diagram illustrating an example of a configuration of a cloud.

FIGS. 5A to 5C are diagrams illustrating an example of screen transition until an estimated ink levels screen is displayed.

FIGS. 6A to 6C are diagrams illustrating an example of screen transition until a maintenance screen is displayed.

FIG. 7 illustrates an example of a document 1400 describing a procedure for displaying the estimated ink levels screen.

FIG. 8 is a diagram illustrating an example of a document 2400 describing a procedure for cleaning an ink head.

FIG. 9 is a diagram illustrating an example of a process for generating a knowledge base.

FIG. 10 is a conceptual diagram of a process for generating a knowledge base from the document 1400.

FIG. 11 is a conceptual diagram of a process for generating a knowledge base from the document 2400.

FIG. 12 is a diagram illustrating an example of the knowledge base.

FIGS. 13A to 13D are diagrams illustrating examples of prompts created by a CPU 101.

FIG. 14 is a diagram illustrating an example of a process executed by an application of the printing apparatus according to a first exemplary embodiment.

FIG. 15 is a diagram illustrating an example of display of a message created for a question.

FIG. 16 is a diagram illustrating an example of a process executed by an application of the printing apparatus according to a second exemplary embodiment.

FIG. 17 is a diagram illustrating an example of display of messages created for a question.

FIG. 18 is a diagram illustrating an example of a sequence from when a user asks a question to when an output of a language model is displayed on a panel.

### DESCRIPTION OF THE EMBODIMENTS

Hereinafter, exemplary embodiments of the present disclosure will be described in detail with reference to the accompanying drawings. The following exemplary embodiments do not limit the present disclosure according to the scope of the claims. While a plurality of features is described in the exemplary embodiments, not all of the plurality of features is necessary to the present disclosure, and the features may be combined in any given way.

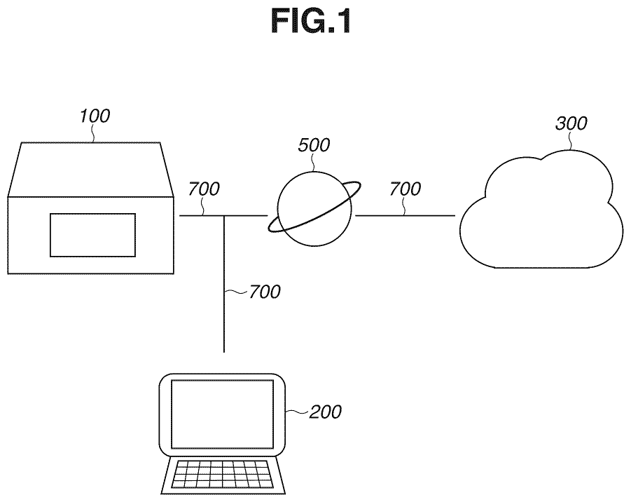

FIG. 1 is a diagram illustrating an example of a configuration of a system according to a first exemplary embodiment. The system includes a printing apparatus 100, an information processing apparatus 200, and a cloud 300. The printing apparatus 100 and the information processing apparatus 200 are connected to the Internet 500 via a network 700. The Internet 500 is connected to the cloud 300 via the network 700. As described above, the printing apparatus 100 and the information processing apparatus 200 are connected to the cloud 300, all of which are communicable with each other.

In the present disclosure, any combination of the printing apparatus 100, the information processing apparatus 200, and the cloud 300 may be used. For example, instead of including the information processing apparatus 200 and the cloud 300 as constituents, the printing apparatus 100 may have the functions of the information processing apparatus 200 and the cloud 300, so that the printing apparatus 100 alone constitutes the system.

The printing apparatus 100 is an image forming apparatus or an image processing apparatus, such as a multifunction peripheral, a printer, a copier, or a scanner, and is an example of an office machine. What is performed by the cloud 300 may be executed by the printing apparatus 100 and/or the information processing apparatus 200. In the following exemplary embodiments, the printing apparatus 100 will be described as an example, but the present disclosure is not limited to the printing apparatus 100. Another type of apparatus, such as a camera or a home appliance, may be used. Further, instead of the printing apparatus 100, the information processing apparatus 200, such as a smartphone or a personal computer, may be used.

The system may operate by the printing apparatus 100 and the information processing apparatus 200 operating in cooperation with each other. For example, a configuration may be employed in which the information processing apparatus 200, such as a smartphone, accepts a voice input of a user and then acquire an answer to the voice input from a language model, the information processing apparatus 200 transmits the result to the printing apparatus 100, and the printing apparatus 100 displays the answer.

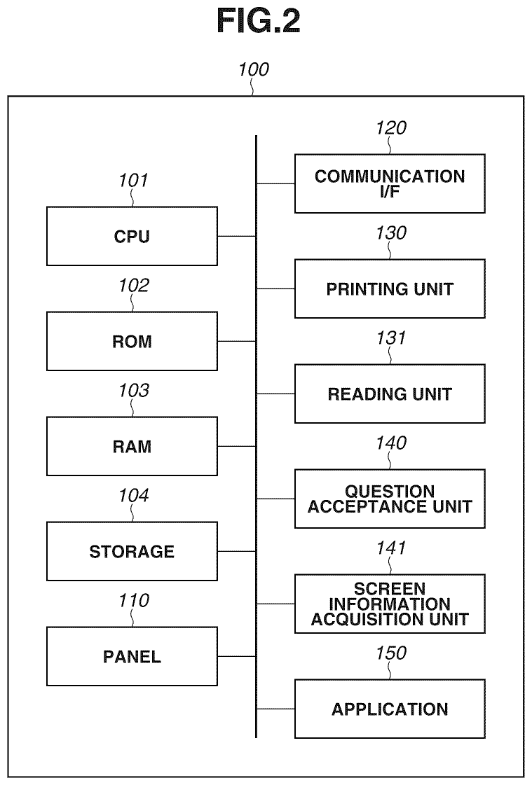

FIG. 2 is an example of a configuration of the printing apparatus 100. The printing apparatus 100 includes a central processing unit (CPU) 101, a read-only memory (ROM) 102, a random access memory (RAM) 103, a storage 104, a panel 110, a communication interface (I/F) 120, a printing unit 130, a reading unit 131, a question acceptance unit 140, a screen information acquisition unit 141, and an application 150. None of all the components are essential.

The CPU 101 generally controls the operation of the printing apparatus 100. The CPU 101 reads a control program stored in the ROM 102 or the storage 104, and executes the program to control each unit and perform calculation to carry out functions of the printing apparatus 100, such as printing and reading.

The ROM 102 stores control programs executable by the CPU 101. The ROM 102 is controlled by the CPU 101, and the CPU 101 reads a control program from the ROM 102 to execute the program. The RAM 103 is a main storage memory of the CPU 101, and is used as a temporary storage area for loading various control programs stored in a working area, the ROM 102, and the storage 104. The storage 104 is a storage area for storing all pieces of information, such as print data, image data, various programs, and various setting information, in addition to control programs executable by the CPU 101.

The panel 110 is an operation panel which can display screens and accept inputs from users. When the printing apparatus 100 is powered on, icons and buttons for using functions of the printing apparatus 100, such as copying, scanning, and printing, are displayed on the panel 110. Users can use these functions by operating the panel 110.

The communication I/F 120 is used for connecting to the network 700 to transmit and receive data to and from an external system on the network 700, for example, the cloud 300.

The printing unit 130 is used for printing images based on image data stored in the RAM 203 or the storage 204 on print media (recording paper) fed from not-illustrated paper feed cassettes.

The reading unit 131 reads an image of a document, and then the CPU 101 converts the image into image data, such as binary data. The image data generated based on the image read by the reading unit 131 is transmitted to an external device or printed on recording paper. The reading unit 131 may have a configuration including a document placement area, and configured to read a document with, for example, a scanner by feeding the document set on the document placement area. Alternatively, the reading unit 131 may have a configuration configured to read a document by capturing an image of the document with a camera. The reading unit 131 is not an essential unit of the printing apparatus 100.

The question acceptance unit 140 accepts questions from users. The method of accepting questions may be carried out through voice input, via a software key displayed on the panel 110, via a not-illustrated hardware key connected to the printing apparatus 100, or the like. The question acceptance unit 140 may accept an instruction, such as “Show how to display the XX screen”, as well as questions. That is, the question acceptance unit 140 accepts inputs of questions, instructions, or the like in natural languages from users.

The screen information acquisition unit 141 is used for acquiring screen shots of screens displayed on the panel 110, identifiers of screens being displayed, and the like. The application 150 is executed by the CPU 101 on the printing apparatus 100, and is software for implementing the present disclosure.

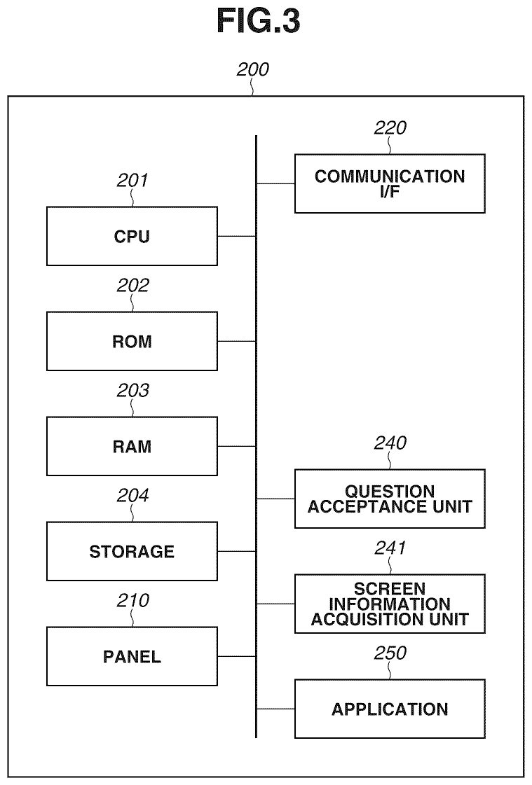

FIG. 3 is an example of a configuration of the information processing apparatus 200. The information processing apparatus 200 includes a CPU 201, a ROM 202, a RAM 203, a storage 204, a panel 210, a communication I/F 220, a question acceptance unit 240, a screen information acquisition unit 241, and an application 250. None of all the components are essential.

The CPU 201 generally controls the operation of the information processing apparatus 200. The CPU 201 reads a control program stored in the ROM 202 or the storage 204, and executes the program to control each unit and perform calculation to carry out the functions of the information processing apparatus 200. The ROM 202 stores control programs executable by the CPU 201.

The ROM 202 is controlled by the CPU 201, and the CPU 201 reads a control program from the ROM 202 to execute the program. The RAM 203 is a main storage memory of the CPU 201, and is used as a temporary storage area for loading various control programs stored in a working area, the ROM 202, and the storage 204. The storage 204 is a storage area for storing all pieces of information, such as print data, image data, various programs, and various setting information, in addition to control programs executable by the CPU 201.

The panel 210 is an operation panel which can display screens and accept inputs from users. A user interface (UI) of the application 250 of the information processing apparatus 200 and the like are displayed on the panel 210.

The communication I/F 220 is used for connecting to the network 700 to transmit and receive data to and from an external system on the network 700, for example, the cloud 300.

The question acceptance unit 240 accepts questions from users. The method of accepting questions may be carried out through voice input, via a software key displayed on the panel 110, via a not-illustrated hardware key connected to the information processing apparatus 200, or the like.

The screen information acquisition unit 241 is used for acquiring screen shots of screens displayed on the panel 210, identifiers of screens being displayed, and the like. The application 250 is executed by the CPU 201 on the information processing apparatus 200, and is software for implementing the present disclosure. The application 250 may be software in a different form from an application, such as a driver.

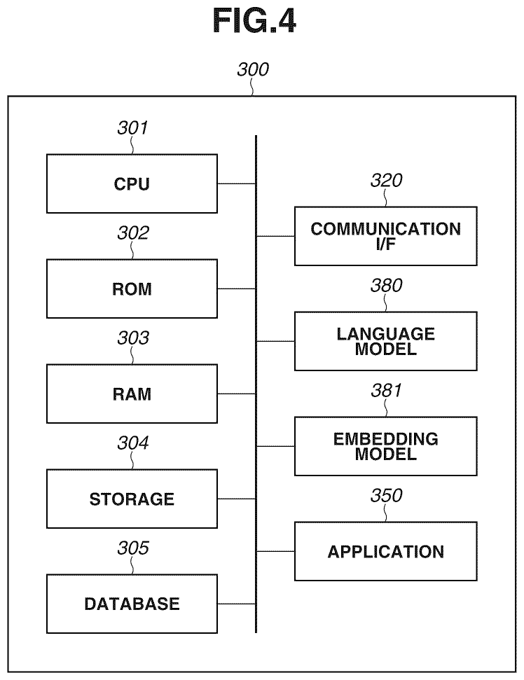

FIG. 4 is an example of a configuration of the cloud 300. The cloud 300 includes a CPU 301, a ROM 302, a RAM 303, a storage 304, a database 305, a communication I/F 320, an application 350, a language model 380, and an embedding model 381. None of all the components are essential.

The CPU 301 generally controls the operation of the cloud 300. The CPU 301 reads a control program stored in the ROM 302 or the storage 304, and executes the program to control each unit and perform calculation to carry out the functions of the cloud 300.

The ROM 302 stores control programs executable by the CPU 301. The ROM 302 is controlled by the CPU 301, and the CPU 301 reads a control program from the ROM 302 to execute the program. The RAM 303 is a main storage memory of the CPU 301, and is used as a temporary storage area for loading various control programs stored in a working area, the ROM 302, and the storage 304. The storage 304 is a storage area for storing all pieces of information, such as print data, image data, various programs, and various setting information, in addition to control programs executable by the CPU 301.

The database 305 is built to operate in a cloud environment. The database 305 can store structured data, unstructured data, and semi-structured data. The communication I/F 320 is used for connecting to the network 700 to transmit and receive data to and from an external system, such as the printing apparatus 100 and the information processing apparatus 200 on the network 700.

The language model 380 is a model that has been trained on a large amount of data. When a question is input to the language model 380, an answer to the question is output in text. The input to the language model 380 is performed in text or with an image. The language model 380 may be a large language model (LLM) or a small language model (SLM), and the scale of the model is not limited. The language model 380 may be a multimodal language model that also handles image input.

The embedding model 381 is a model that converts an input natural language into a vector. The language model 380 may be included in the printing apparatus 100 or the information processing apparatus 200.

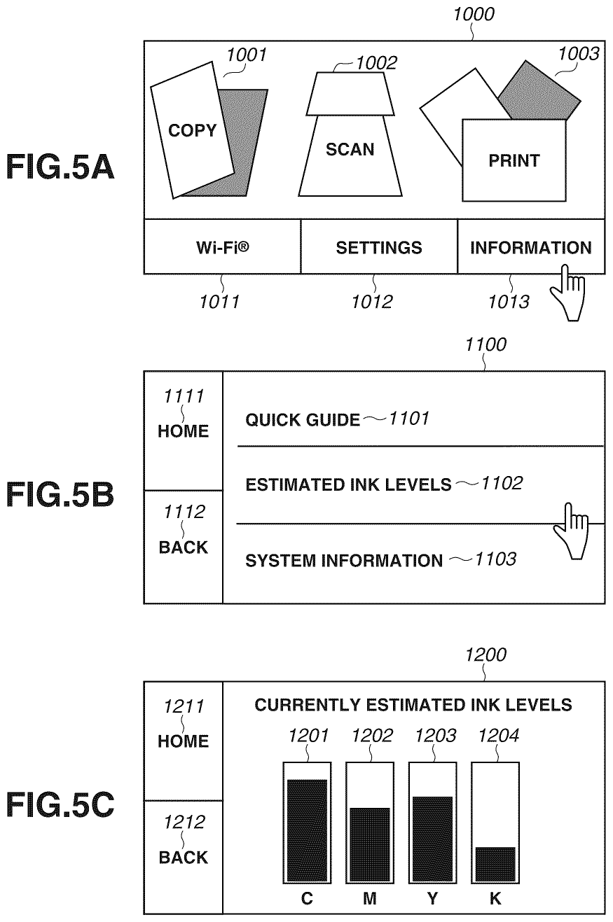

FIGS. 5A to 5C illustrate an example of screen transition until an estimated ink levels screen 1200 is displayed on the panel 110 of the printing apparatus 100.

FIG. 5A is a home screen 1000 displayed on the panel 110 of the printing apparatus 100. The home screen 1000 is the initial screen displayed on the panel 110 after the printing apparatus 100 is powered on. The home screen 1000 includes a copy icon 1001, a scan icon 1002, and a print icon 1003. A lower portion of the home screen 1000 includes a Wi-Fi® button 1011, a settings button 1012, and an information button 1013.

When a user selects the copy icon 1001, the screen transitions to a screen for executing copying. The description of the screen for executing copying will be omitted. When the user selects the scan icon 1002, the screen transitions to a screen for executing scanning. The description of the screen for executing scanning will be omitted. When the user selects the print icon 1003, the screen transitions to a screen for executing printing. The description of the screen for executing printing will be omitted.

When the user selects the Wi-Fi® button 1011, the screen transitions to a screen for setting Wi-Fi®. The description of the screen for setting Wi-Fi® will be omitted. When the user selects the settings button 1012, the screen transitions to a screen for configuring various settings of the printing apparatus 100 (hereinafter, referred to as a settings screen 2100). When the user selects the information button 1013, the screen transitions to a screen for displaying various types of information about the printing apparatus 100 (hereinafter, referred to as an information screen 1100).

FIG. 5B illustrates the information screen 1100 displayed on the panel 110 of the printing apparatus 100.

The information screen 1100 includes a quick guide button 1101, an estimated ink levels button 1102, and a system information button 1103. A home button 1111 and a back button 1112 are provided on the left of the information screen 1100.

When the user selects the quick guide button 1101, a quick guide is displayed.

The description of the quick guide will be omitted. When the user selects the estimated ink levels button 1102, the estimated ink levels screen 1200 illustrated in FIG. 5C is displayed. When the user selects the system information button 1103, a screen related to system information is displayed. The description of the screen related to the system information will be omitted. When the user selects the home button 1111, the screen transitions to the home screen 1000. When the user selects the back button 1112, the screen transitions to the previous screen, here, the home screen 1000.

FIG. 5C illustrates the estimated ink levels screen 1200 displayed on the panel 110 of the printing apparatus 100. Estimated ink levels (remaining amounts) of various inks are displayed in a column chart on the estimated ink levels screen 1200. A cyan estimated ink level 1201, a magenta estimated ink level 1202, a yellow estimated ink level 1203, and a black estimated ink levels 1204 are displayed.

The user can understand the remaining amounts by checking the estimated ink levels screen 1200, and can consider, for example, the time to order a replacement ink. When the user selects a home button 1211, the screen transitions to the home screen 1000. When the user selects a back button 1212, the screen transitions to the previous screen, here, the information screen 1100.

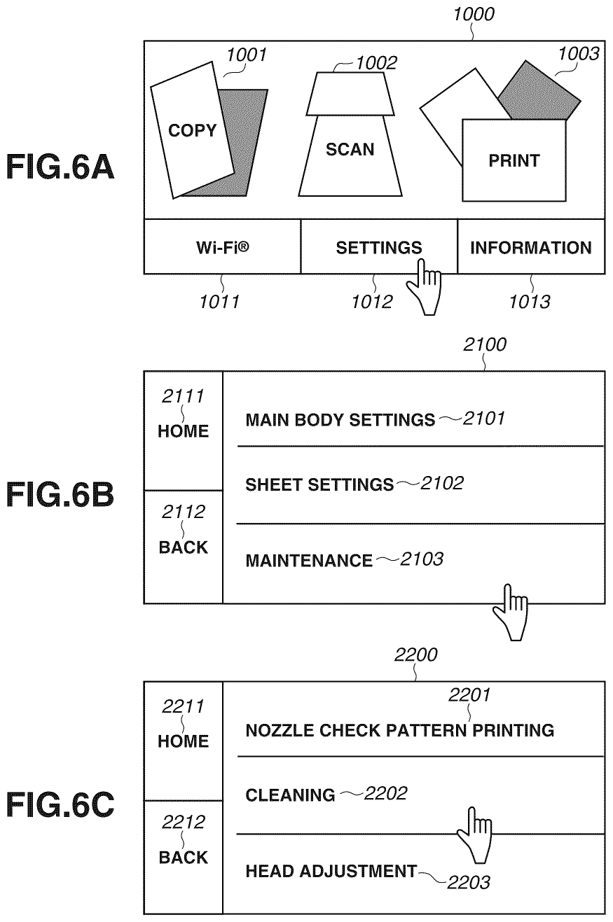

FIGS. 6A to 6C illustrate an example of screen transition until a maintenance screen 2200 is displayed on the panel 110 of the printing apparatus 100.

FIG. 6A illustrates the home screen 1000 displayed on the panel 110 of the printing apparatus 100. The home screen 1000 has been described above, and thus the description thereof will be omitted.

FIG. 6B illustrates the settings screen 2100 displayed on the panel 110 of the printing apparatus 100.

The settings screen 2100 includes a main body settings button 2101, a sheet settings button 2102, and a maintenance button 2103. A home button 2111 and a back button 2112 are provided on the left of the settings screen 2100.

When the user selects the main body settings button 2101, a screen related to main body settings is displayed.

The description of the screen related to main body settings will be omitted. When the user selects the sheet settings button 2102, a screen related to sheet settings is displayed. The description of the screen related to sheet settings will be omitted. When the user selects the maintenance button 2103, the maintenance screen 2200 illustrated in FIG. 6C is displayed. When the user selects the home button 2111, the screen transitions to the home screen 1000. When the user selects the back button 2112, the screen transitions to the previous screen, here, the home screen 1000.

FIG. 6C illustrates the maintenance screen 2200 displayed on the panel 110 of the printing apparatus 100. The maintenance screen 2200 includes a nozzle check pattern printing button 2201, a cleaning button 2202, and a head adjustment button 2203. A home button 2211 and a back button 2212 are included on the left of the maintenance screen 2200. When the user selects the home button 2211, the screen transitions to the home screen 1000. When the user selects the back button 2212, the screen transitions to the previous screen, here, the settings screen 2100.

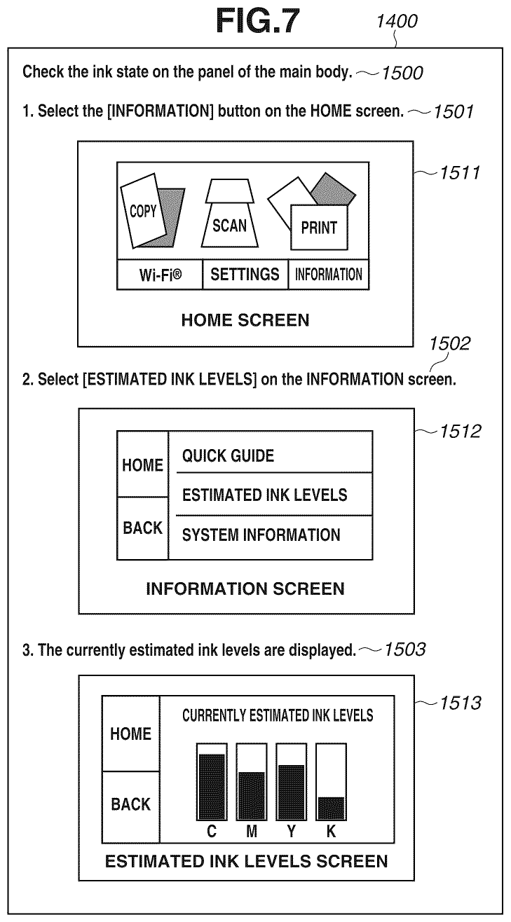

FIG. 7 illustrates a document 1400 describing a procedure for displaying the estimated ink levels screen 1200. The document 1400 includes texts 1500 to 1503, and images 1511 to 1513.

The text 1500 is the title of this document 1400, describing how to check the ink status. The text 1501 is a procedure 1 for displaying the estimated ink levels screen 1200.

It is described in the text 1501 that the information button 1013 is to be selected on the home screen 1000. The image 1511 is an image illustrating the home screen 1000.

The text 1502 is a procedure 2 for displaying the estimated ink levels screen 1200.

It is described in the text 1502 that the estimated ink levels button 1102 is to be selected on the home screen 1000. The image 1512 is an image illustrating the information screen 1100.

The text 1503 is a procedure 3 for displaying the estimated ink levels screen 1200.

It is described in the text 1503 that the estimated ink levels screen 1200 is to be displayed so that the estimated ink levels can be checked. The image 1513 is an image illustrating the estimated ink levels screen 1200.

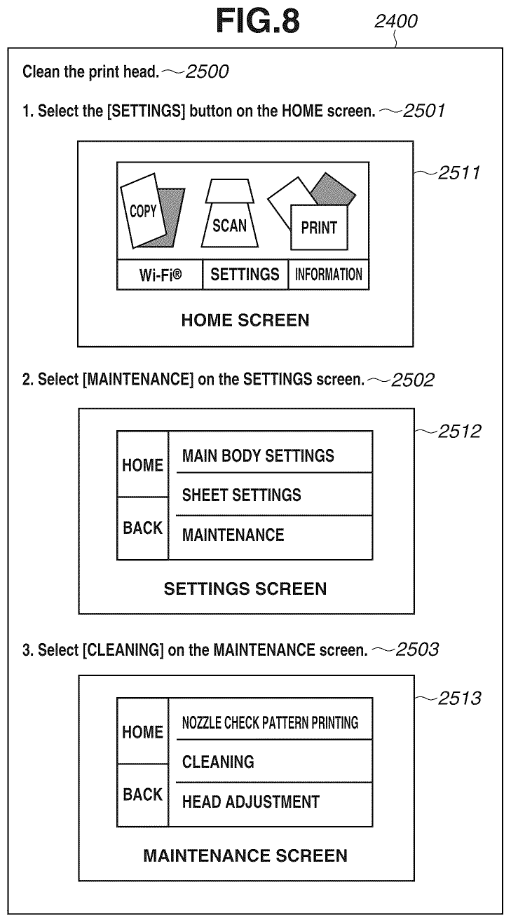

FIG. 8 illustrates a document 2400 describing a procedure for cleaning an ink head. That is, the document 2400 describes a procedure until the maintenance screen 2200 is displayed. The document 2400 includes texts 2500 to 2503, and images 2511 to 2513.

It is described in the text 2500 that the printhead is to be cleaned as the title of the document 2400. The text 2501 is a procedure 1 for displaying the maintenance screen 2200.

It is described in the text 2501 that the settings button 1012 is to be selected on the home screen 1000. The image 2511 is an image illustrating the home screen 1000.

The text 2502 is a procedure 2 for displaying the maintenance screen 2200. It is described in the text 2502 that the maintenance button 2103 is to be selected on the home screen 1000. The image 2512 is an image illustrating the settings screen 2100.

The text 2503 is a procedure 3 for displaying the maintenance screen 2200. It is described in the text 2503 that the cleaning button 2202 is to be selected. The image 2513 is an image illustrating the maintenance screen 2200.

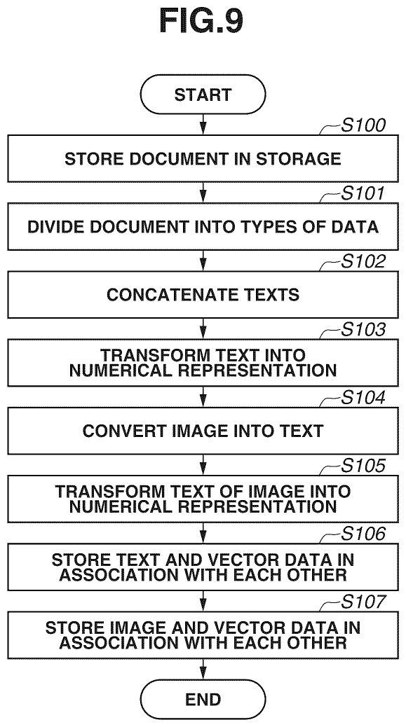

FIG. 9 is an example of a process for generating a knowledge base. The knowledge base is a database that is an information source to be given to a language model, for example, Retrieval-Augmented Generation (RAG) or the like. In the following description, the symbol “S” stands for step. RAG provides a highly accurate answer by searching a knowledge base for information close to the content of a question from a user and inputting the information obtained through the search and the question of the user in combination to the language model 380.

FIG. 9 is a flowchart illustrating a process executed by the application 350 of the cloud 300. The process is executed by the CPU 301 of the cloud 300 loading programs stored in the ROM 302 into the RAM 203 to run the application 350. The process is started in response to when a not-illustrated knowledge base creation function is started. The knowledge base may be created only once or a plurality of times at desired timings.

In step S100, the CPU 301 saves a document to the storage 304 in the cloud 300. Documents are an information source in which information, such as a file, is described, and become an information source of a knowledge base by being accumulated in the storage 304. The documents stored in the storage 304 include, for example, the document 1400 in which a method of checking estimated ink levels is described, the document 2400 in which a method of cleaning nozzles is described, and the like.

A document may be a user manual for the printing apparatus 100 or newly created when a system of the present disclosure is created. A document may constitute a single page or a file including a plurality of pages. For example, a document may be a single Portable Document Format (PDF) file in which how to use the printing apparatus 100, such as a method of checking estimated ink levels and a method of cleaning nozzles, is described over a plurality of pages. The file format may be any format.

In step S101, the CPU 301 divides the documents by data type, such as text, tables, and images. For example, in a case where a document is a single PDF file including a plurality of pages, various types of data, such as text, tables, and images, are often mixed in the file. It is often difficult for the language model 380 to determine such a file, so that the content of the document is divided into data types, such as text, tables, and images, before the document is input to the language model 380.

Such a division may be carried out by an existing typical application or library, such as a PDF parser. If the divided text is long, the text may be further divided into a plurality of texts. The segmentation of the text may be achieved using common existing language processing applications or libraries. The text may be divided based on the number of characters in the text, the meaning of the text, or the like.

In step S102, the CPU 301 concatenates texts divided in step S101 with each other, the texts having close meanings. For example, if 10 texts are obtained in step S101, texts having close meanings are concatenated to create a total of three texts. The process of concatenating similar texts may be implemented using an existing language processing application or library. This concatenation process is not essential to the present disclosure. For example, the texts obtained in step S101 may be used as they are in subsequent step(s) after step S103. In this case, the processing of step S102 is not performed.

In step S103, the CPU 301 transforms the texts obtained in step S101 or S102 into numerical representations. The transformation of texts into numerical representations may be performed by the embedding model 381 using the divided texts, and when a text is input to the embedding model 381, vector data can be obtained. In the present disclosure, the method of transformation into vector data is not limited. For example, the transformation into vector representations may be performed by another method, such as using a Word2Vec method. The type of data created by transforming text into numerical representations is not limited to vector data, and may be another type of numerical data.

In step S104, the CPU 301 converts the image divided in step S101 into text. As a method of converting an image into text, for example, there is a method of using the multimodal language model 380. For example, a prompt, such as “Describe this image”, and the image are input to the language model 380, providing a text describing the content of the image.

A prompt is a character string, such as words or a document, for instructing what a user wants the language model 380 to generate. While an example of converting an image into text using a multimodal language model has been described, an image may be converted into text by another method. For example, an image including character-level information may be subjected to Optical Character Reader (OCR) processing to extract the character-level information and text is retrieved from the character-level information.

In step S105, the CPU 301 transforms the text obtained from the image in step S104 into numerical representations.

That transformation may be performed by using a similar method to the method described in step S103.

In step S106, the CPU 301 stores the text obtained in step S101 and the numerical data obtained in step S103 in association with each other in the database 305. The database 305 stores data as a set of a key and a value. Here, the key is the numerical data obtained in step S103, and the value is the text obtained in step S101. A value obtained by some transformation, such as summarization of the text obtained in step S101, may be used.

In step S107, the CPU 301 stores the image obtained in step S101 and the numerical data obtained in step S105 in association with each other in the database 305.

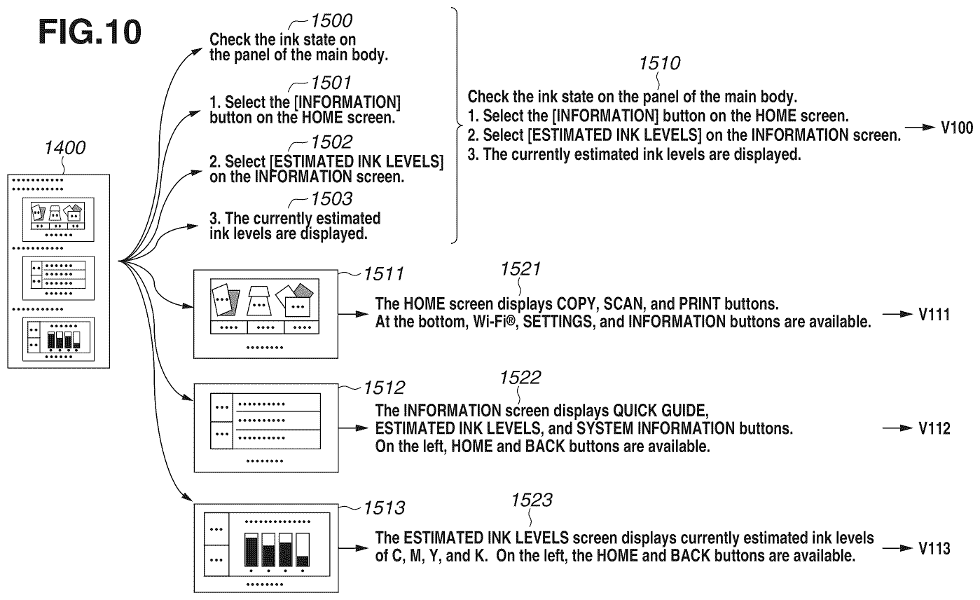

FIG. 10 is a conceptual diagram of a process for generating a knowledge base from the document 1400.

The texts 1500 to 1503 and the images 1511 to 1513 are obtained through the division of the document 1400. The text 1510 is obtained by concatenating the texts 1500 to 1503. A vector V100 is obtained by transforming the text 1510 into numerical representations.

Here, “V” stands for a vector. The texts 1521 to 1523 are obtained by converting the images 1511 to 1513 into texts. The texts are each a text of the content describing the corresponding image. Vectors V111 to V113 are obtained by transforming the texts 1521 to 1523 into numerical representations.

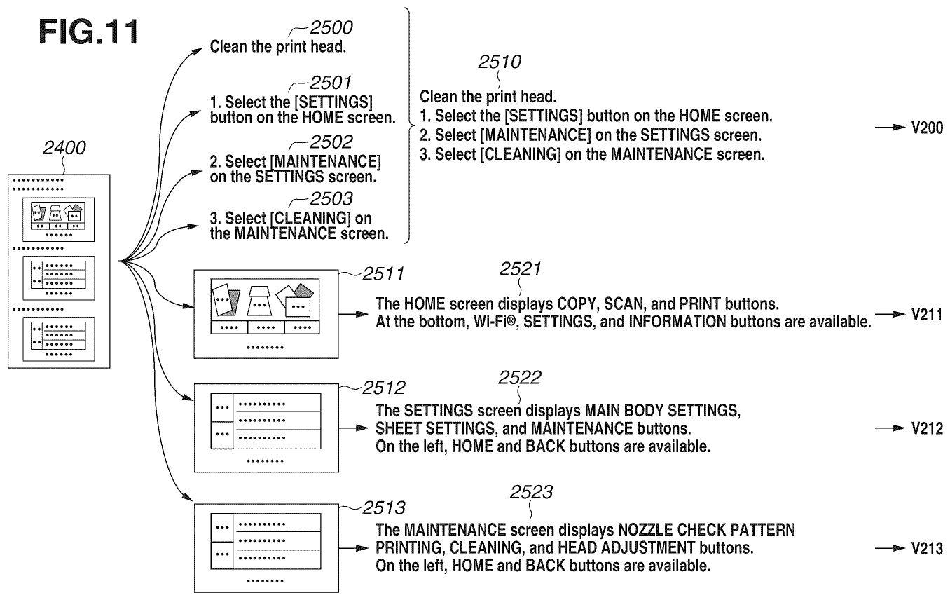

FIG. 11 is a conceptual diagram of a process for generating a knowledge base from the document 2400.

The texts 2500 to 2503 and the images 2511 to 2513 are obtained by dividing the document 2400. A text 2510 is obtained by concatenating the texts 2500 to 2503. A vector V200 is obtained by transforming the text 2510 into numerical representations.

Texts 2521 to 2523 are obtained by converting the images 2511 to 2513 into texts. These texts are each a text of the content describing the corresponding image. Vectors V211 to V213 are obtained by transforming the texts 2521 to 2523 into numerical representations.

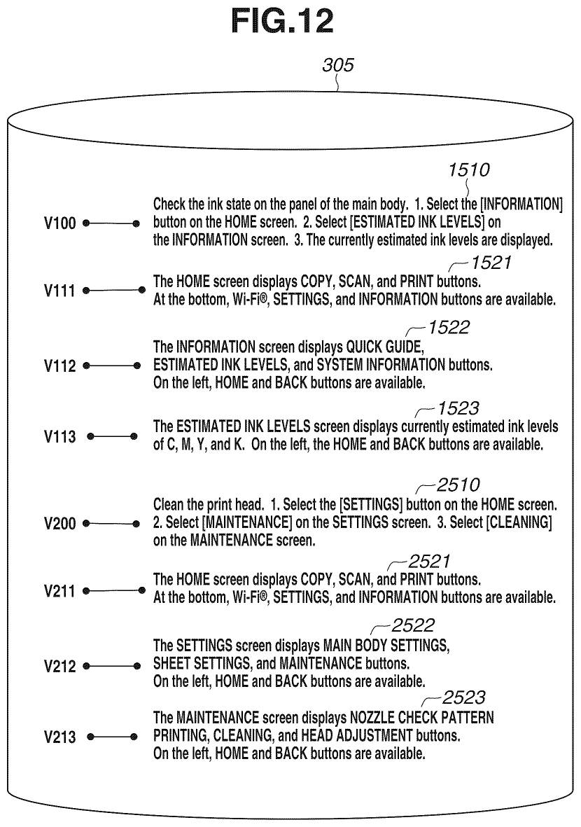

FIG. 12 is a diagram illustrating an example of a knowledge base stored in the database 305. Specifically, the information created in FIGS. 10 and 11 is stored in the database 305. The text 1510 and the vector V100 obtained by transforming the text 1510 into numerical representations are stored in association with each other in the database 305. In addition, the texts 1521 to 1523 and the vectors V111 to V113 obtained by converting the images 1511 to 1513 into numerical representations are stored in the database 305 with each text associated with the corresponding vector.

Similarly, the text 2510 and the vector V200 obtained by transforming the text 2510 into numerical representations are stored in association with each other in the database 305. In addition, the texts 2521 to 2523 and the vectors V211 to V213 obtained by converting the images 2511 to 2513 into numerical representations are stored in the database 305 with each text associated with the corresponding vector. Thus, information related to one or more documents is stored and stored in the database 305.

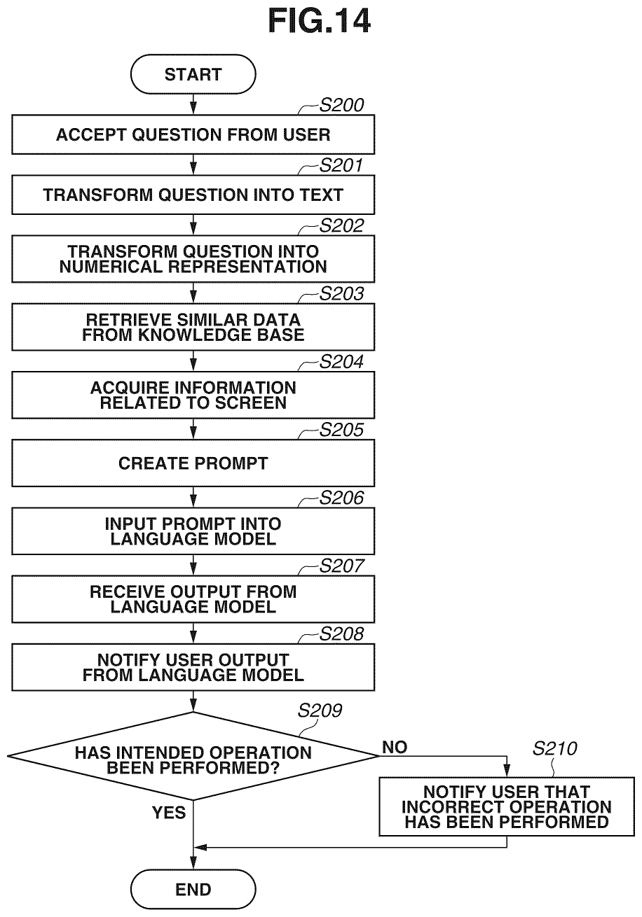

FIG. 14 is a diagram illustrating an example of a process executed by the application 150 of the printing apparatus 100. This process is executed by the CPU 101 of the printing apparatus 100 reading programs stored in the ROM 102 into the RAM 203 to run the application 150.

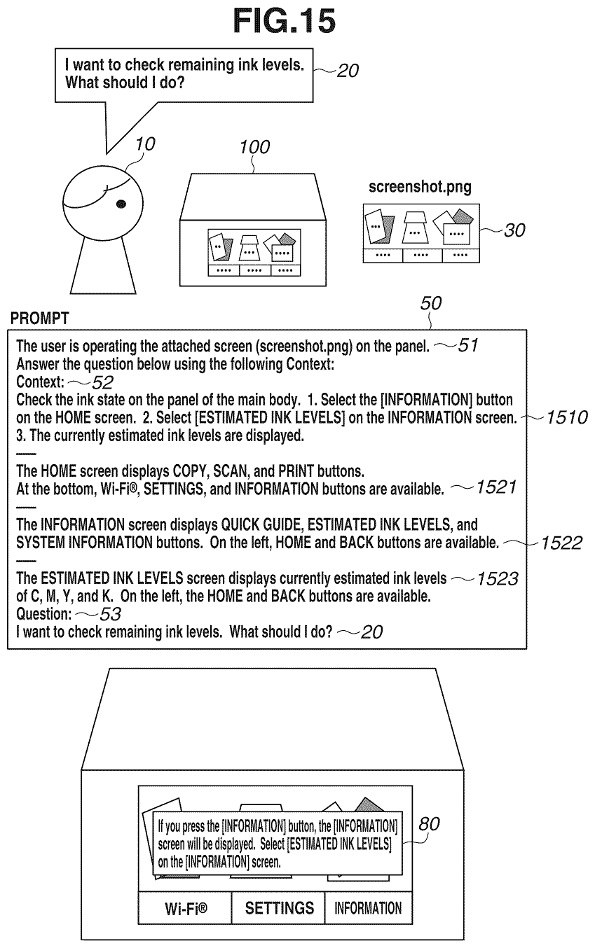

This process is started when the printing apparatus 100 becomes able to accept a user's question through a press of a button or the like. If the printing apparatus 100 can accept a user's question at any time, this process may be started in response to when the printing apparatus 100 is powered on. In the description of FIG. 14, FIG. 15, which illustrates the process of FIG. 14, will also be used.

In step S200 of FIG. 14, the CPU 101 controls the question acceptance unit 140 to accept a question from a user 10. That is, the CPU 101 accepts a natural language from the user 10. For example, the printing apparatus 100 includes a voice input device, such as a microphone, and the CPU 101 accepts a question via voice input when the user 10 utters a sound toward the microphone.

Instead of creating a question sentence from a voice input, the printing apparatus 100 may be provided with an input device, such as a software or hardware keyboard, so that the CPU 101 accepts a user's question by the user's inputting (text input) the question using the input device. The present disclosure may employ an input method other than that described above, and is not limited to the method as long as a question from a user can be accepted.

In step S201 of FIG. 14, the CPU 101 transforms the question accepted in step S200 into text. For example, when a question is accepted via voice input, the voice data is converted into text by transcription or the like. In the following description, the converted text is referred to as a question text. In step S200, if a question from the user is accepted in text by, for example, keyboard input, the processing of step S201 may not be executed.

In step S202 of FIG. 14, the CPU 101 transforms the question text obtained in step S201 into numerical representations.

The present disclosure is not limited to a method of transformation into numerical representations. For example, the question text may be input to the embedding model 381 and converted into numerical data, such as vector data. If the embedding model 381 is included in the cloud 300, the CPU 101 controls the communication I/F 120 to transmit the question text to the cloud 300, and the embedding model 381 in the cloud 300 transforms the question text into numerical representations.

The reception of the numerical data by the printing apparatus 100 allows the printing apparatus 100 to transform the question text into numerical representations. The present disclosure is not limited to a method of transformation into numerical representations using the embedding model 381. For example, the transformation into numerical data, such as vector data, may be performed using word occurrence probabilities, such as Bag of Words. In the present disclosure, it is not essential to transform the question text into numerical representations, and the text may be held as it is without transformation into numerical representations. In this case, the processing of step S202 is not performed.

In step S203 of FIG. 14, the CPU 101 retrieves from the knowledge base similar data to the question accepted from the user in step S200. In the knowledge base, as illustrated in FIG. 12, texts extracted from documents and numerical data are stored in association with each other. That is, the eight texts 1510 and 1521 to 1523, and 2510 and 2521 to 2523 extracted from the documents and eight pieces of numerical data as the vectors V100 and V111 to V113, and V200 and V211 to V213 are stored with each text associated with the corresponding vector.

By calculating the distances between the vector data (Vq) about the question text generated in step S202 and the vectors V100 and V111 to V103, and V200 and V201 to V213, N close distances are found. In the present disclosure, the method of calculating the distance between two pieces of numerical data is not limited. For example, when performing calculation using vector data, a method, such as cosine similarity, may be used. N values corresponding to N keys having short distances, respectively, are similar pieces of data. For example, when N=2, if the vectors V100 and V111 are close to Vq, the similar text data is the texts 1510 and 1521 corresponding to the vectors V100 and V111, respectively.

In the above description, the question text is transformed into numerical values, and data having a short distance is regarded as similar data. However, the present disclosure is not limited to that method. For example, similar data may be retrieved by using a search method using text, such as a full-text search or a keyword search, without transformation of text into numerical representations. In the above-described method of retrieving similar data, the similar data is retrieved from the knowledge base. However, the present disclosure is not limited to that method. For example, by inputting a question to a trained model that has been additionally trained on specific documents, as a fine-tuned model, similar data close to the question may be retrieved.

In step S204 of FIG. 14, the CPU 101 controls the screen information acquisition unit 241 to acquire information related to the screen displayed on the panel 110. The information related to the screen includes, for example, “a name of a screen”, “a screen shot of a screen”, “a text into which a screen shot of a screen is converted”, and “an identifier of a screen”. What the CPU 101 acquires at that time is information related to the screen displayed on the panel 110 when the user's question is accepted in step S200.

The first “a name of a screen” is a name of a screen, such as “home screen” or “maintenance screen”. In this case, the CPU 101 acquires the name of the screen displayed on the panel 110 when a user asks a question.

The second “a screen shot of a screen” is a screen shot of a screen being operated by a user. The CPU 101 acquires a screen shot of the screen displayed on the panel 110 when a user asks a question. In FIG. 15, a screen shot 30 is a screen shot of the home screen 1000. The screen shot 30 is saved to the RAM 103 or the storage 104 under its file name screenshot.png. The screen shot is an example of image data, and the extension may be peg, gif, or the like.

The third “a text into which a screen shot of a screen is converted” is a text obtained by the CPU 101 inputting a prompt “Summarize the image of this screen shot” and the screen shot 30 into the multimodal language model 380. That text is text data about the content describing information about the screen shot 30.

The conversion of a screen shot into text may be performed in other ways. For example, the screen shot 30 may be subjected to OCR processing to extract characters from the screen shot and transform the characters. The CPU 101 acquires a screen shot of a screen displayed on the panel 110 when a user asks a question, and converts the screen shot into text.

The fourth “an identifier of a screen” is a character string or a number registered in the storage 104 or the like in association with a corresponding screen. For example, identifiers are each registered in association with a corresponding screen, such as Screen 1 for the home screen 1000 and Screen 100 for the estimated ink levels screen 1200. The CPU 101 acquires an identifier corresponding to a screen displayed on the panel 110 when a user asks a question.

In step S205 of FIG. 14, the CPU 101 creates a prompt to transmit to the language model 380. The prompt is created using the user's question (natural language) accepted in step S200, and may be created in the accepted natural language as it is or using something into which the natural language is converted so that the language model can be easily determined.

Examples of information included in the prompt include “information related to the question”, “information related to similar data”, and “information related to the screen”. By including those pieces of information in the prompt, it is possible to obtain an answer to the question from the user based on the information in the knowledge base with respect to the screen operated by the user. That is, it is not necessary to include all of these pieces of information in the prompt.

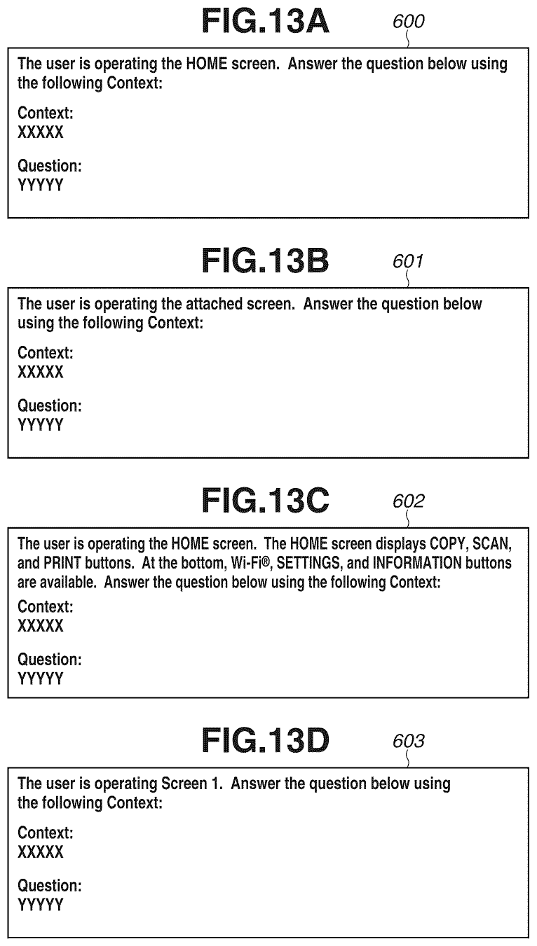

FIGS. 13A to 13D illustrate examples of prompts created by the CPU 101 of the printing apparatus 100 in step S205.

FIG. 13A is an example of a case where the information related to the screen is “a name associated with a screen”. A prompt 600 states: “The user is operating the HOME screen. Answer the question below using the following Context. Context: XXXXX Question: YYYYY”.”

The expression “the HOME screen” included in the prompt 600 corresponds to “information related to the screen”. Information related to similar data is entered in XXXXX of Context. Information related to the question is entered in YYYYY of Question.

FIG. 13B is an example of a case where information related to the screen is a “a screen shot of a screen”. A prompt 601 states: “The user is operating the attached screen. Answer the question below using the following Context. Context: XXXXX Question: YYYYY”.

The expression “the attached screen” included in the prompt 601 refers to “a screen shot of a screen”. Information related to similar data is entered in XXXXX of Context. Information related to the question is entered in YYYYY of Question.

FIG. 13C is an example of a case where the information related to the screen is “a text into which a screen shot of a screen is converted”. A prompt 602 states: “The user is operating the HOME screen. The HOME screen displays COPY, SCAN, and PRINT buttons. At the bottom, Wi-Fi®, SETTINGS, and INFORMATION buttons are available. Answer the question below using the following Context. Context: XXXXX Question: YYYYY”.

The prompt 602 contains information, such as a button related to the home screen. That information is obtained by converting the screen shot of the screen into a text. Information related to similar data is entered in XXXXX of Context. Information related to the question is entered in YYYYY of Question.

FIG. 13D is an example of a case where the information related to the screen is “An identifier associated with a screen”. A prompt 603 states: “User is operating Screen 1. Answer the question below using the following Context. Context: XXXXX Question: YYYYY”.

The expression “Screen 1” included in the prompt 603 corresponds to “an identifier associated with a screen” described above. Information related to similar data is entered in XXXXX of the context. Information related to the question is entered in YYYYY of the question.

A prompt 50 of FIG. 15 is an example of a case where the prompt 50 is created by applying the processing of steps S200 to S205 to a question 20 from the user 10. The prompt 50 is an example of a case where the information related to the screen is “a screen shot of a screen” as described with reference to FIG. 13B. The prompt 50 is composed of a prompt heading 51, a context item 52, and a question item 53.

The prompt heading 51 states that while the user 10 is operating the screen corresponding to screenshot.png on the panel 110, the prompt 50 prompts the application 150 to answer the question item 53 using the context item 52.

The context item 52 lists similar pieces of data for the question 20. In this example, the texts 1510, and 1521 to 1523 are listed as the similar pieces of data to the question 20. In this example, the user 10 has asked the question 20 about estimated ink levels, so that the texts 1510, and 1521 to 1523 related to the estimated ink levels are listed as the similar pieces of data. Those similar pieces of data are retrieved from the knowledge base (in step S203).

The question item 53 states the question 20 from the user 10. While the content of the question 20 from the user 10 is described as it is at the question item 53 in FIG. 15, the present disclosure is not limited the example. For example, the user 10's question converted into a form that is easily determined by the language model 380 under the control of the CPU 101 may be entered at the question item 53. Both the user 10's question as it is and the converted question may be entered at the question item 53. For example, if the user 10's question is long, a summary created by summarizing the content thereof in advance by the language model 380 may be entered at the question item 53.

In step S206 of FIG. 14, the CPU 101 controls the communication I/F 120 to input the prompt 50 created in step S205 into the language model 380. In a case of the prompts 600, and 602 and 603 illustrated in FIGS. 13A and 13C and 13D, the prompt is transmitted to the language model 380.

In this case, an image corresponding to the prompt may also be input to the language model 380. On the other hand, in a case of the prompt 601 illustrated in FIG. 13B, an image that is a screen shot of a screen is input to the language model 380 together with the prompt 601. In addition, the image input here is a screen shot of the screen displayed when the natural language is accepted in step S200. In this case, the language model 380 is a multimodal language model into which an image can be also input.

In a case where the language model 380 is included in the printing apparatus 100, the CPU 101 transmits prompts to the language model 380 in the printing apparatus 100. In a case where the language model 380 is included in the cloud 300, the CPU 101 controls the communication I/F 120 to transmit prompts to the cloud 300, and the received prompt is input to the language model 380 of the cloud 300 that has received the prompt. The language model 380 that has received the prompt in this manner executes processing in accordance with the received prompt.

In step S207 of FIG. 14, the CPU 101 receives the output from the language model 380 via the communication I/F 120. In a case where the language model 380 is included in the cloud 300, the CPU 101 receives the output from the language model 380 via the communication I/F 120 from the cloud 300. In a case where the language model 380 is included in the printing apparatus 100, the CPU 101 receives the output from the language model 380. In this case, the language model 380 performs output based on the prompt and the image input by the CPU 101 in step S206.

In step S208 of FIG. 14, the CPU 101 causes the panel 110 to display the output from the language model 380 received in step S207 to present the output to the user 10. The output of the language model 380 is an operation method for the printing apparatus 100, and is an operation method that is performed on the screen displayed on the panel 110 when the natural language is accepted in step S200.

In FIG. 15, the output (answer) from the language model 380 is displayed on the panel 110 as a message 80. The message 80 states the content prompting the user 10 to select the information button 1013 and then select the estimated ink levels button 1102 on the information screen that is subsequently displayed. This is an example of the answer indicating an operation up to the estimated ink levels screen 1200 that the user 10 finally wants to reach.

The first exemplary embodiment is an example for giving an answer for collective operations necessary for implementing a function that a user wants to execute. That is, an answer is displayed on the screen on the panel 110 being displayed when the user 10 asks the question, the answer indicating the operations to be performed from the screen displayed on the panel 110 at the time when the user 10 asks the question to the screen that the user 10 finally wants to reach. The user 10 can find out the operation up to the estimated ink levels screen 1200 by looking at the message 80.

In this manner, answers from the language model 380 are displayed on the panel 110 of the printing apparatus 100. The method of presenting the user 10 with answers from the language model 380 is not limited to that method. As an example of another presentation method, if the printing apparatus 100 includes a voice output device, such as a speaker, answers from the language model 380 may be converted into speech and informed (conveyed) to the user 10 via audio.

In step S209 of FIG. 14, the CPU 101 detects whether the user 10 has performed the intended operation. The intended operation is an operation that the user 10 has performed in accordance with the content presented to the user 10 in step S208. For example, as illustrated in FIG. 15, when the user 10 asks the question 20“I want to check remaining ink levels. What should I do?”, a message is displayed on the home screen 1000.

The message is the message 80 “If you press the [INFORMATION] button, the [INFORMATION] screen will be displayed. Select [ESTIMATED INK LEVELS] on the [INFORMATION] screen”. In this case, if the user 10 presses the information button 1013 on the home screen 1000, the intended operation is performed. On the other hand, for example, when the user 10 selects the settings button 1012 on the home screen 1000, the operation is not intended. The configuration of step S209 is not essential to the present disclosure.

In step S210 of FIG. 14, the CPU 101 causes the panel 110 to display a message indicating that an incorrect operation has been performed, and presents (notifies) to the user 10. This operation is performed when the user 10 has performed an operation different from the content presented in step S208 (NO in step S209).

If the CPU 101 detects an unintended operation in step S209 (NO in step S209), the processing proceeds to step S210. In step S210, the message indicating that an unintended operation has been performed is displayed. Examples of the message includes a message “Not the [information] but [Settings] button is pressed. Please go back to the previous screen with the [Back] button.” and a message “An incorrect operation has been performed. Please press the [HOME] button on the left of the screen to return to the [HOME] screen”. The configuration of the step S210 is not essential to the present disclosure.

A second exemplary embodiment of the present disclosure will be described. The contents described in FIGS. 1 to 13 are the same as those in the first exemplary embodiment described above, and thus the description thereof will be omitted. In the first exemplary embodiment, the example has been described in which operations up to displaying a final screen are collectively displayed in response to a user's question. In contrast, in the second exemplary embodiment, an example will be described in which, for one question from a user, the CPU 101 queries to the language model 380 and receives a response every time the user 10 makes a screen transition, and presents the response to the user 10 every time the screen transition is made.

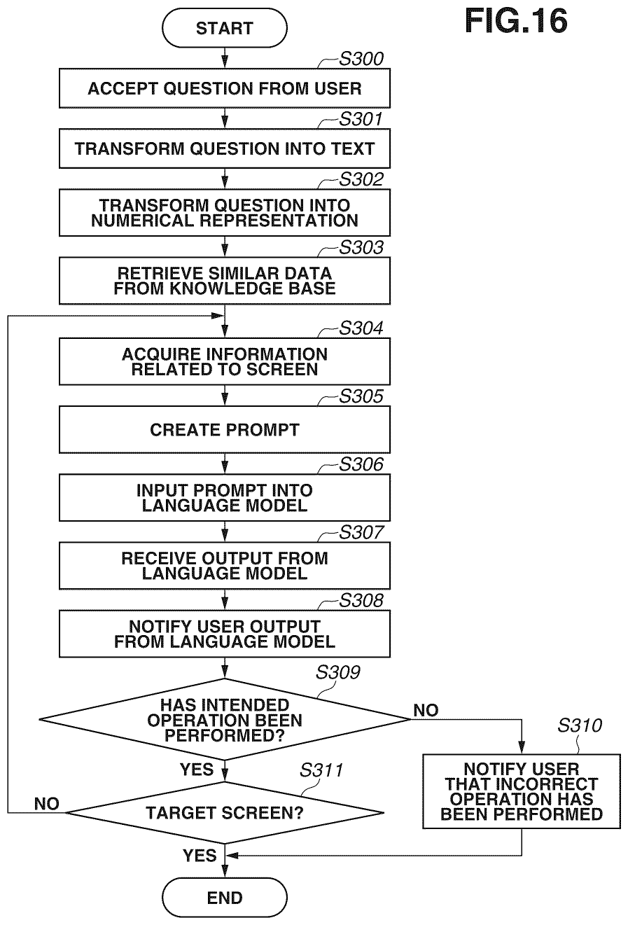

FIG. 16 is a flowchart illustrating an example of the second exemplary embodiment. The flowchart illustrates a process executed by the application 150 of the printing apparatus 100. The process is executed by the CPU 101 of the printing apparatus 100 reading programs stored in the ROM 102 into the RAM 203 and causing the programs to run the application 150. The process is started when the printing apparatus 100 becomes able to accept a question from a user by the user's pressing a button or the like.

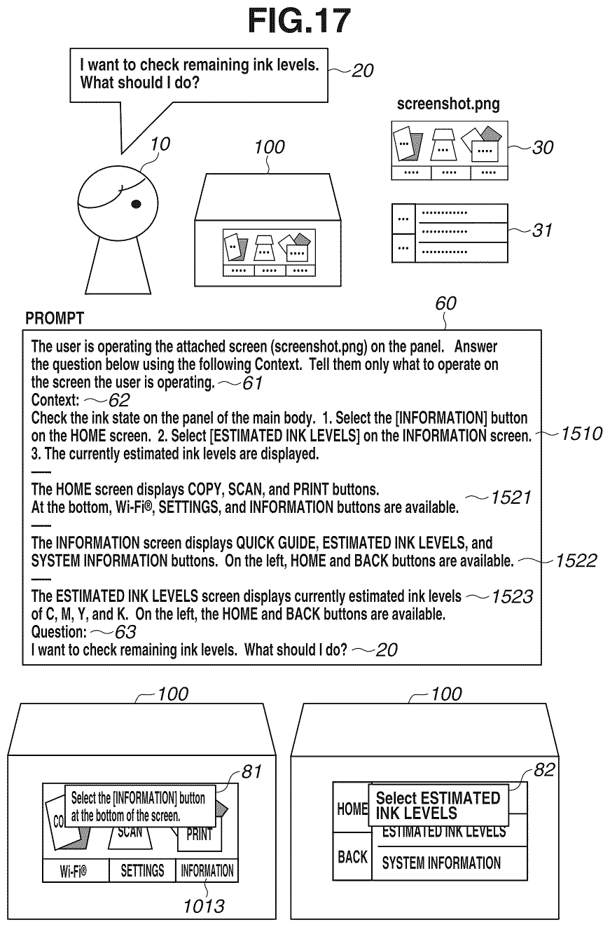

With the printing apparatus 100 capable of accepting a question from the user 10 at any time, the process may be started at the time when the printing apparatus 100 is powered on. FIG. 17 illustrates the process in FIG. 16. In FIG. 17, the user 10 makes the question 20 “I want to check remaining ink levels. What should I do?”.

The processing in steps S300 to S304 in FIG. 16 are the same as that of steps S200 to S204 described in FIG. 14 of the first exemplary embodiment, and thus the description thereof will be omitted. As a result of step S304 in FIG. 16, the screen shot 30 is acquired as information related to the screen as illustrated in FIG. 17. The screen shot 30 is a screen shot of the home screen 1000. In the following description, the file name of the screen shot 30 is screenshot.png.

In step S305 of FIG. 16, the CPU 101 creates a prompt to transmit to the language model 380. The information included in the prompt is the same as that described in the first exemplary embodiment, and the description thereof will be omitted.

FIG. 17 illustrates an example of the prompt. A prompt 60 illustrated in FIG. 17 is composed of a prompt heading 61, a context item 62, and a question item 63. The prompt heading 61 states that while the user 10 is operating the screen “screenshot png” on the panel 110, the prompt 60 prompts the application 150 to answer the question item 63 using the context item 62. In addition to the content of the prompt heading 51 described in the first exemplary embodiment, the prompt heading 61 states: “Tell them only what to operate on the screen that the user 10 is operating.”

With this added description, the answer from the language model 380 is limited to what the user 50 should operate on the screen. That is, unlike the message 80 of the first exemplary embodiment, the message does not describe operations up to a final screen, but displays the operations to be performed in stages. The context item 62 is the same as the context item 52 in FIG. 15, and thus the description thereof will be omitted. The question item 63 is the same as the question item 53 in FIG. 15, and thus the description thereof will be omitted.

In step S306 of FIG. 16, the CPU 101 controls the communication I/F 120 to input the screen information obtained in step S304 and the prompt created in step S305 to the language model 380. The description of that processing will be omitted because it is the same as that of step S206.

In step S307 of FIG. 16, the CPU 101 receives the output of the language model 380 via the communication I/F 120. The description of that processing will be omitted because it is the same as that of step S207.

In step S308 of FIG. 16, the CPU 101 causes the panel 110 to display the output from the language model 380 received in step S307 to present the output to the user 10. FIG. 17 illustrates an example of the output (answer) from the language model 380 displayed on the panel 110.

While the user 10 is displaying the home screen 1000, a message 81 is displayed on the panel 110. The message 81 states: “Select the [INFORMATION] button at the bottom of the screen”. The expression “at the bottom of the screen” is included in the text 1521 obtained through the conversion of the image 1511. In this way, if the text into which an image is converted includes positional information about an operation control, such as a button, a message can be displayed that prevents the user 10 from being confused in the operation.

In step S309 of FIG. 16, the CPU 101 detects whether the intended operation has been performed. The description of that processing will be omitted because it is the same as that of step S209.

In step S310 of FIG. 16, the CPU 101 notifies the user 10 that an incorrect operation has been performed. The description of that processing will be omitted because it is the same as that of step S210.

In step S311 of FIG. 16, the CPU 101 detects whether the application 150 has transitioned to a target screen. When the CPU 101 detects that the application 150 has transitioned to the target screen (YES in step S311), the process is terminated. On the other hand, when the CPU 101 detects that the application 150 has transitioned to a screen different from the target screen (NO in step S311), the processing returns to step S304.

The target screen will be described with reference to FIG. 17. Here, the target screen is a screen that the user 10 wants to display or a screen for executing a function that the user wants to execute. In FIG. 17, the question 20 from the user 10 is “I want to check remaining ink levels. What should I do?”, so that the target screen corresponds to the estimated ink levels screen 1200.

When the user 10 receives the message 81 and selects the information button 1013, the screen of the panel 110 transitions to the information screen 1100. Since the information screen 1100 after the screen transition is different from the estimated ink levels screen 1200 as the target screen, in step S311, the CPU 101 determines that the screen has not transitioned to the target screen (NO in step S311), and the processing returns to the processing of step S304.

When it is determined that the result in step S311 is NO in FIG. 16, the processing of step S304 is executed again. In step S304, information related to the screen is acquired which is here information related to a screen after the transition, i.e., information related to the information screen 1100. In this example, the screen shot 31 of the information screen 1100 is acquired as the information related to the information screen 1100. The file name of the screen shot 31 is screenshot.png.

The processing of steps S305 to S307 when executed for the second and subsequent times is the same as the processing that is executed for the first time, and thus the description thereof will be omitted. In the processing of step S308 when executed for the second time in this example, a message 82 “Select ESTIMATED INK LEVELS.” is displayed. This is because screenshot.png specified at the prompt heading 61 is a screen shot of the information screen 1100. By the user 10's looking at the message 82 and selecting the estimated ink levels button 1102, the screen of the panel 110 transitions to the estimated ink levels screen 1200.

In the processing of step S311 when executed for the second and subsequent times, the CPU 101 determines whether the screen has transitioned to a target screen. In this example, the target screen is the estimated ink levels screen 1200, and the panel 110 also displays the estimated ink levels screen 1200. As a result, the CPU 101 determines that the target screen has been reached (YES in step S311). The process is thus completed. If the CPU 101 determines that the target screen has not been reached even in step S311 when executed for the second time (NO in step S311), the processing returns to step S304, and the third processing is started. The CPU 101 repeats the processing until the CPU 101 determines that the screen has transitioned to the target screen in step S311.

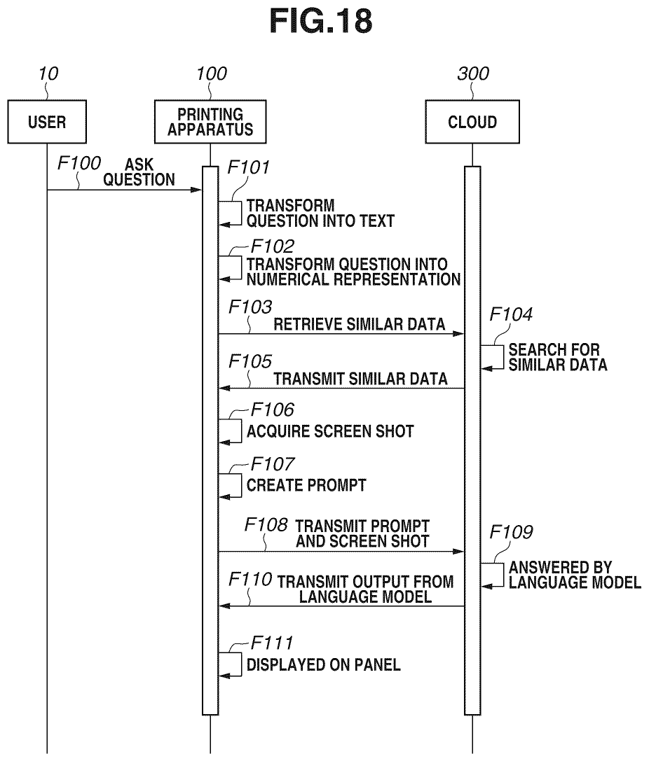

FIG. 18 illustrates an example of the sequence according to the first and second exemplary embodiments from when a user asks a question until the output from the language model 380 is displayed on a panel. The characters in the sequence diagram are the user 10, the printing apparatus 100, and the cloud 300. The printing apparatus 100 may be the information processing apparatus 200.

In step F100, the user 10 asks the printing apparatus 100 a question, and the printing apparatus 100 accepts the question via the question acceptance unit 140 (in steps S200 and S300).

In step F101, the CPU 101 of the printing apparatus 100 transforms the question accepted in step F100 into text (in steps S201 and S301).

In step F102, the CPU 101 of the printing apparatus 100 transforms the question text obtained through the transformation in step F101 into numerical representations (in steps S202 and S302).

In step F103, the CPU 101 of the printing apparatus 100 controls the communication I/F 120 to transmit to the cloud 300 a request to retrieve similar data to the question received in step F100, and the request is received by the cloud 300.

In step F104, the CPU 301 of the cloud 300 searches for similar data to the question accepted by the printing apparatus 100 in step F100 in response to receiving the retrieval request from the printing apparatus 100 in step F103.

In step F105, the CPU 301 of the cloud 300 controls the communication I/F 320 to transmit the similar data retrieved in step F104 to the printing apparatus 100 (in steps S203 and S303).

In step F106, the CPU 101 of the printing apparatus 100 acquires a screen shot of the screen displayed on the panel 110 (in steps S204 and S304).

In step F107, the CPU 101 of the printing apparatus 100 uses the question accepted in step F100 and the similar data received in step F105 to create a prompt to transmit to the language model 380 (in steps S205 and S305).

In step F108, the CPU 101 of printing apparatus 100 controls the communication I/F 120 to transmit the screen shot acquired in step F106 and the prompt created in step F107 to the cloud 300 (in steps S206 and S306).

In step F109, the CPU 301 of the cloud 300 acquires an answer by inputting the screen shot and the prompt into the language model 380 and causes the language model 380 to perform processing.

In step F110, the CPU 301 of the cloud 300 controls the communication I/F 320 to transmit to the printing apparatus 100 the answer (the output) obtained from the language model 380 in step F109, and the answer is received by the printing apparatus 100 (in steps S207 and S307).

In step F111, the CPU 101 of the printing apparatus 100 causes the panel 110 to display the answer (the output) from the language model 380 received in step F110 (in steps S208 and S308).

The present disclosure can also be implemented by a process in which a program that implements one or more functions of the above-described exemplary embodiments is supplied to a system or an apparatus via a network or a storage medium, and one or more processors in a computer of the system or the apparatus read and execute the program. The present disclosure can also be implemented by a circuit (e.g., an application-specific integrated circuit (ASIC)) that implements one or more functions.

According to the present disclosure, a user can easily cause a multifunction peripheral to display a desired screen. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An information processing apparatus comprising:
a display configured to display a screen;
at least one memory storing instructions; and
at least one processor that, upon execution of the stored instructions, is configured to operate as:
an acceptance unit that accepts a natural language from a user;
a transmission unit that transmits information about the screen displayed when the acceptance unit accepts the natural language and a prompt using the accepted natural language, the information being transmitted being based on the accepted natural language; and
a reception unit that receives an output from a language model, the output being based on the transmitted information about the screen and the transmitted prompt,
wherein the display is caused to display the received output from the language model, the output indicating an operation method for the information processing apparatus that is displayed on the screen displayed by the display after the acceptance unit accepts the natural language.

2. The information processing apparatus according to claim 1, wherein execution of the stored instructions further causes the at least one processor to display the received output on the screen displayed after the acceptance unit accepts the natural language, through the reception of the output by the reception unit.

3. The information processing apparatus according to claim 2, wherein execution of the stored instructions further configures the at least one processor to operate as a notification unit that issues a notification based on an operation performed by the user after the output is caused to be displayed on the screen.

4. The information processing apparatus according to claim 3, wherein the notification unit notifies the user that the operation different from the operation method indicated by the displayed output has been performed in a case where the user has performed an operation different from the operation method indicated by the displayed output.

5. The information processing apparatus according to claim 1,
wherein based on a transition of another screen by the user's operation after the output is displayed by the display, the transmission unit transmits both information about a screen after the transition and the prompt using the accepted natural language,
wherein the reception unit receives an output from the language model, the output being based on the transmitted information about the screen after the transition and the transmitted prompt, and
wherein the received output is caused to be displayed on the other screen.

6. The information processing apparatus according to claim 1, wherein execution of the stored instructions further configures the one or more processors to operate as a search unit that searches for data similar to the accepted natural language,
wherein the transmission unit transmits information about the screen displayed when the natural language is accepted and a prompt using the accepted natural language and the data retrieved by the search unit.

7. The information processing apparatus according to claim 1, wherein the transmission unit transmits a prompt based on the information about the screen displayed when the natural language is accepted and the accepted natural language.

8. The information processing apparatus according to claim 1, wherein the acceptance unit accepts the natural language by voice input.

9. The information processing apparatus according to claim 1, wherein the acceptance unit accepts the natural language by text input.

10. The information processing apparatus according to claim 1, wherein the prompt using the natural language is a prompt including the natural language accepted from the user by the acceptance unit.

11. The information processing apparatus according to claim 1, wherein the prompt using the natural language is a prompt converted based on the natural language accepted from the user by the acceptance unit.

12. The information processing apparatus according to claim 1, wherein the information about the screen includes a name associated with the screen.

13. The information processing apparatus according to claim 1, wherein the information about the screen includes image data about the screen.

14. The information processing apparatus according to claim 13, wherein the image data includes a screen shot of the screen.

15. The information processing apparatus according to claim 7, wherein the information about the screen is obtained by converting a screen shot of the screen into text.

16. The information processing apparatus according to claim 1, wherein the information about the screen includes an identifier associated with the screen.

17. The information processing apparatus according to claim 1, comprising an audio output unit,
wherein the audio output unit outputs the output received by the reception unit as audio.

18. A non-transitory computer-readable storage medium for storing a program for causing a computer to execute each unit of the information processing apparatus according to claim 1.

19. A method of controlling an information processing apparatus, comprising:
displaying, as display, a screen;
accepting, as acceptance, a natural language from a user;
transmitting information about the screen displayed when the natural language is accepted in the acceptance and a prompt using the accepted natural language, the information being transmitted being based on the accepted natural language; and
receiving, as reception, an output from a language model, the output being based on the transmitted information about the screen and the transmitted prompt,
wherein the output indicates an operation method for the information processing apparatus that is displayed on the screen displayed in the display after the natural language is accepted in the acceptance.
